(19) United States
(12) Patent Application Publication
(10) Pub. No.: US 2009/0198585 A1
(43) Pub. Date: Aug. 6, 2009

(54) Vote up count down

(76) Inventor: Chris Wollstein, New York, NY (US)

Correspondence Address: Paul E Schaafsma, NovusIP, LLC, Suite 221, 521 West Superior Street, Chicago, IL, 60610, US

(21) Appl. No.: 12/012,658

(22) Filed: Feb. 5, 2008

(51) Int. Cl. G06Q 30/00

(52) U.S. Cl. 705/26

(57) ABSTRACT

An electronic commerce system of auctioning products on-line is provided. An auctioneer presents a list of available products to consumers. The products may be present to consumers using a web site. Customers are able to “vote up” as many products as they want. The product that the most customers have voted up will go to a “countdown” sale mode, where it gets progressively less expensive, for example one penny cheaper every second, until someone purchases the product. Once someone purchases the product, the next product with the most votes immediately replaced it and goes into countdown mode.

### FIELD OF THE INVENTION

The present invention relates to e-commerce.

### BACKGROUND OF THE INVENTION

The Internet is a global network of computers. Network servers support hypertext capabilities that permit the Internet to link together webs of documents. User interfaces such as Graphical User Interfaces (GUI) are typically used to navigate the Internet to retrieve relevant documents. Uniform Resource Locators (URLs) are used to identify specific web sites and web pages on the Internet. URLs also identify the address of the document to be retrieved from a network server. The Transfer Control Protocol/Internet Protocol (TCP/IP) is used to transfer information.

The Internet uses a hypertext language referred to as the hypertext mark-up language (HTML). HTML is a commonly used scripting or programming language that permits content providers or developers to place hyperlinks within web pages. These hyperlinks link related content or data, which may be found on multiple Internet host computers. HTML document links may retrieve remote data by use of HyperText Transfer Protocol (HTTP). Alternatively, File Transfer Protocol (FTP) for file transfer, the network news protocol (NNTP) for discussion groups, and the simple mail transport protocol (SMTP) for email or other Internet application protocols can be used. When a user clicks on a link in a web document, the link icon in the document contains the URL that the client employs to initiate the session with the server storing the linked document. HTTP is the protocol used to support the information transfer.

While most of today's users of the Internet believe it is a recent communications phenomenon, the origins of the Internet actually go back several decades. Today's Internet grew out a computer resource-sharing network created in the 1960s by the Advanced Research Projects Agency (ARPA). This computer resource-sharing network, which came to be known as the ARPAnet, was primarily designed by ARPA's chief scientist, Larry Roberts. The initial problem facing a wide-area computer resource-sharing network was how to efficiently transmit digitized information in a reliable way. To solve this problem, in 1968, Roberts mandated use of a packet-switching design in the ARPAnet.

Packet switching breaks up blocks of digitized information into smaller pieces called packets. These packets are transmitted through the network, usually by different routes, and are then reassembled at their destination. Eight years prior to ARPA's Request for Proposal, Len Kleinrock invented packet switching. See, e.g., Len Kleinrock, “Information Flow in Large Communications Nets,” RLE Quarterly Progress Report (1960); Len Kleinrock, Communication Nets (1964). See also Paul Baren, “On Distributed Communications Networks,” IEEE Transactions on Systems (March 1964). Roberts believed that packet switching was the means to efficiently transmit digitized information in a reliable way.

The next problem to solve was how to interconnect a number of mainframe computers, most of which utilized different languages and different operating systems. Wesley Clark of Washington University in St. Louis, Mo., devised the solution to this huge incompatibility problem. Clark proposed that a smaller microcomputer should interface between every mainframe and the network. All of these minicomputers would run on the same operating system and use the same language. Each mainframe, therefore, would only be required to interface with its own minicomputer, with the minicomputer translating into the network operating system and language. These Interface Message Processors (IMP), which provided an interface between the ARPAnet host mainframe computers and the ARPAnet, were the predecessors to today's routers. With this basic design, the first two nodes on the ARPAnet communicated on 1 Oct. 1969.

By 1971, 15 nodes, mostly academic institutions, were up on the ARPAnet; however, the original goal of the ARPAnet was not being realized. Resource sharing of the mainframe computers was simply too cumbersome. In March 1972, Ray Tomlinson of consulting firm Bolt, Beranek & Newman invented e-mail. Use of this message transfer program quickly grew to be the initial major use of the ARPAnet.

By the mid-seventies, the ARPAnet was not the only network utilizing switching packets. Once again, an incompatibility problem emerged. Each of these different networks used a different protocol. Thus, interconnection of these different networks was not possible. The solution, devised by Robert Kahn of ARPA and Vincent Cerf of Stanford University, was called the Transmission Control Protocol/Internet Protocol. The Transmission Control Protocol packetized information and reassembled the information upon arrival. The Internet Protocol routed packets by encasing the packets between networks. See, e.g., Robert Kahn and Vincent Cerf, “A Protocol for Packet Network Intercommunication,” IEEE Transactions on Communications Technology (May 1974). Transmission Control Protocol/Internet Protocol was adopted by the ARPAnet in 1983. With the addition of the Domain Name System (DNS) in November 1983, the now familiar Internet address protocol was established.

A final step in creating the Internet occurred in 1990, when an Englishman, Tim Berners-Lee working at the European Center for Particle Research (CERN) in Switzerland, invented the World Wide Web. This software, based on a program Berners-Lee had written in 1980 to allow users to store information using random associations, allowed material from any computer, from any format to be translated into a common language of words, images, and addresses. Berners-Lee's program established the three core components of the World Wide Web: the Universal Resource Locator, Hypertext Transfer Protocol, and HyperText Markup language.

The initial focus of e-commerce technologies on the Internet was to facilitate business-to-consumer (B2C) transactions. This lead to a frenzy of investment into nearly any Internet related B2C idea, even where the idea lacked real merit. This investment frenzy came to an abrupt end when the Internet valuation bubble burst in March 2000: from its March 2000 of 5,047.69, the technology rich NASDAQ stock index fell over 40%.

Increasingly, however, businesses are finding economies in transacting business-to-business (B2B) over the Internet in a phenomenon that has come to be known as Web2.0. Thus, the World Wide Web has become a new mass media system for information distribution. With the help of advertising support, new media companies have created thousands of news, sports, entertainment, and special interest web sites.

The HTML and HTTP standards have been adapted to handle two-way communication. Specifically, an HTTP server may present an HTML “form” to a user's web browser. That HTML form may be filled-in by the user and send back to the HTTP server. Using a processing system, the HTTP server can obtain the information from the returned HTML form. These interactive HTML/HTTP techniques have been used to create commercial web sites that can perform financial transactions. Internet-based retailers now conduct a very large amount of commercial activity.

Internet based commerce involves a unique set of parameters that cause Internet-based commerce to be very different from brick and mortar storefront-based commerce. With Internet commerce, a transaction can take place between consumer located anywhere and a merchant located anywhere. Furthermore, the computers used in an Internet commerce-based transaction may perform a number of functions to facilitate the transaction. For example, the computer systems may be used to search databases for a particular item, determine availability of that item, calculate total costs including tax and shipping, etc.

These specific parameters of Internet commerce have been partially exploited by some Internet merchants to produce shopping experiences that cannot be obtained with storefront-based commerce. For example, eBay, Inc. (http://www.ebay.com/) has created a large auction site that matches large numbers of individuals with unique items to sell with large numbers of purchasers. The purchasers may search for specific items available for auction using a hierarchical category system or a brute-force search. Thus, by using computer technology, eBay has been able to create a large auction market for individual items. eBay was founded on 3 Sep. 1995 by computer programmer Pierre Omidyar as AuctionWeb, part of a larger personal site.

Another example of such an Internet merchant is described in U.S. Pat. No. 5,794,207, which describes Priceline.com's reverse auction with many sellers. Founded in 1997, priceline.com began selling “name your own price” airline tickets over the Internet in April 1998. A drawback of these user-controlled auctions is that, the users become entangled is a game of bluff and as the time limit for the sale approaches, there is a rush to be the last and therefore successful bidder.

### SUMMARY OF THE INVENTION

In contrast to user-controlled auctions, in accordance with the principles of the present invention the price is controlled by the web server, and not by the users. In accordance with the principles of the present invention, the price is lowered by the web server, rather than raised by the users. The continuously lowering of the price creates a sense of urgency for shoppers: the longer a user waits to make the purchase (price to lower) must be weighed against the fact that another user may buy it up for just a few cents more (a few seconds sooner).

In accordance with the principles of the present invention, an electronic commerce system of auctioning products on-line is provided. An auctioneer presents a list of available products to consumers. The products may be present to consumers using a web site. Customers are able to “vote up” as many products as they want. The product that the most customers have voted up will go to a “countdown” sale mode, where it gets progressively less expensive, for example one penny cheaper every second, until someone purchases the product. Once someone purchases the product, the next product with the most votes immediately replaced it and goes into countdown mode.

### BRIEF DESCRIPTION OF THE DRAWINGS

FIG. 1 is a schematic of a non-limiting example hardware architecture that can be used to run the system of the present invention.

FIG. 2 is a flowchart showing the general user interface process.

FIGS. 3-5 show various database tables used in accordance with the principles of the present invention.

### DETAILED DESCRIPTION OF A PREFERRED EMBODIMENT

In accordance with the principles of the present invention, an electronic commerce system of auctioning products on-line where participants use computer terminals to access a computer site and participate is provided. In the electronic commerce system of the present invention, an auctioneer presents a list of available products to consumers. The products may be present to consumers using a web site. Customers are able to “vote up” as many products as they want. The product that the most customers have voted up will go to a “countdown” sale mode, where it gets progressively less expensive, for example one penny cheaper every second, until someone purchases the product. Once someone purchases the product, the next product with the most votes immediately replaced it and goes into countdown mode.

In one embodiment, a customer can “vote up” as many products as they want, but they can only “vote up” each product one time. Customers cannot see how many “vote up's” a product has, but they can see an “on deck” area with the next for example three products with the most votes. A customer will get an automated e-mail when a product that they have “voted up” goes into countdown mode. A customer also will get an automated e-mail when something that they have “voted up” has entered the “on deck” area to go onto countdown sale.

Continuing the above example, a product counting down a penny a second would countdown $864 over the course of a day. In one embodiment, products that are more expensive than $864 will by default count down at a pace that would bring it down to $0 in 24 hours, that is, for example, a product that starts at $1728 would count down at the rate of two cents per second.

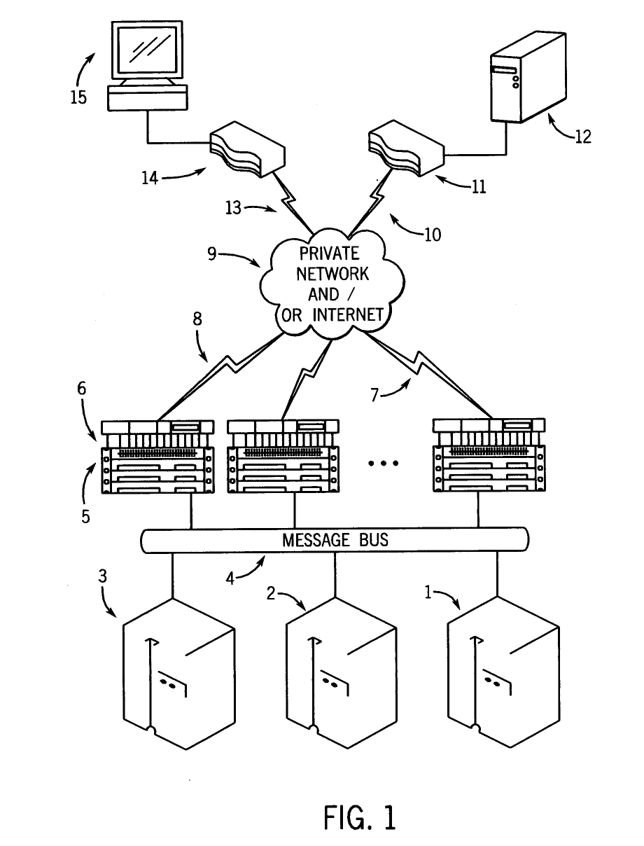

In more detail, the site can be accessed using a web browser, integrated desktop application or any other means of receiving and rendering content from a web server. Referring to FIG. 1, a non-limiting example of a high level implementation that can be used to run a system of the present invention is seen. The infrastructure should include but is not limited to: wide-area network connectivity; network infrastructure; an operating system such as for example Redhat Linux Enterprise Linux AS Operating System available from Red Hat, Inc., 1801 Varsity Drive, Raleigh, N.C.; appropriate network switches and routers; electrical power (backup power); network backup hardware and software, and message software such as for example Tibco SmartSockets messaging software available from Tibco Software Inc., 3303 Hillview Avenue, Palo Alto, Calif.

The match engine (1) and administrative applications server (3) can run for example on an HP Proliant DL740 server with 4 3.0 GHz processors, 64 GB or RAM, 60 GIG Raid level 1 and 1 GHZ network connection, available from the Hewlett-Packard Company, 3000 Hanover Street, Palo Alto, Calif. The database server (2) can be run for example on an HP Proliant DL740 server with 4 3.0 GHz processors, 64 GB or RAM, 300 GIG Raid level 3 and two 1 GHZ network connections, and an active backup system, capable of backing up and restoring while the system is active. The order routing and management applications (5) can be run for example on HP Proliant DL360 server with 2 3.6 GHz processors, 8 GB or RAM, 60 GIG Raid level 1 and 1 GHZ network connection, also available from the Hewlett-Packard Company.

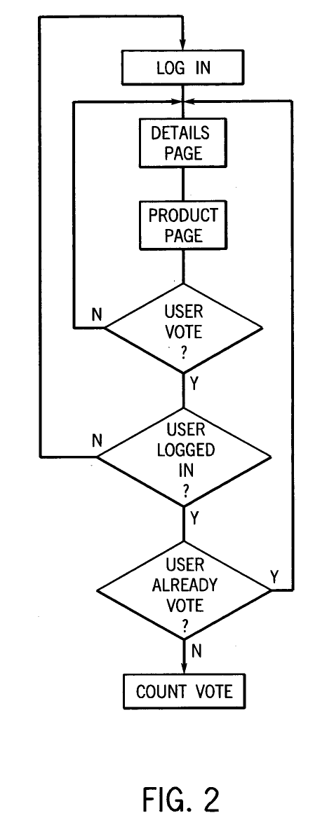

Referring to FIG. 2, the general user interface process is described. Initially, a log in procedure may be done by POSTing to a secure (HTTPS) or non-secure (HTTP) page, and/or though an Asynchronous JavaScript and XML (Ajax) language and/or Flash function available from Adobe Systems Incorporated, 345 Park Avenue, San Jose, Calif. A details page is provided that has full product details, as well as a list of the three products with the most votes that are not currently counting down. This page has a Java-Script and/or Flash Element that lowers the price of the product the appropriate amount every second. This element may also be on other pages, including other people's websites, as a widget.

A product page is provided that can be either a product listing page, the product's own details page or any other place on the site where the user can view details about the product. The vote for a product can be initiated by either sending a GET or POST variable to a new page or by using Ajax and/or Flash technology.

If the user is redirected to a page to count their vote and they are not logged in, they will be prompted to log-in. If the user uses Flash or Ajax technology the server will be returned an error code and message indicating that the user needs to be authenticated.

Once a product has entered into the “countdown” sale mode, the countdowns start time, original price (in cents), count increment, and server's current time are sent into the element. After load the client side element calculates the current price and lowers it every second, in accordance with the following:

‘Current Price’=CEIL(‘Original Price’−((‘Current Time’−‘Start Time’)*‘Count Increment’))

Time can be stored as a UNIX computer operating system time-stamp.

Once a user has submitted their billing and shipping information, the inventory of the product that they have selected can longer be purchased by other users. The details page for the countdown product stays the same for other users; however, when a second user adds the countdown product to their shopping cart, the inventory of the first user is subtracted from the total available stock (yet not actually removed from the inventory until the purchase is completed). If they do not complete the purchase within a specific time limit, the product will be available to other users again and will be removed from the current user's shopping cart. The reserved product inventory will be added to the first user who refreshes their shopping cart and has already selected the product.

The countdown stops for a user at the moment they reserve the inventory (submitted their billing and shipping information). The price the product was at when the user submitted their details is set in the active purchase and is the one that they pay. The summery displays the final costs, including shipping and tax. The credit card submissions are forwarded to a third party payment gateway (for example, authorize.net) and, based on their approval of the submission, the system will take the appropriate actions. When a product is marked as available for countdown, an additional table with properties needed for a countdown is accesses as set forth below.

| | |
|---|---|
| product_id | Referencing back to the product. |
| starting_price | The number that the countdown will start at. |
| increment | The number of cents to be taken off the price per second. In the |
| | admin panel this variable will be pre-populated when the admin |
| | chooses either 1 penny per second, or the length of time the |
| | countdown should last (for purchases that may take too long, or too |
| | short, to countdown). |
| votes | A current count of the number of votes a product has received. This |
| | number can be confirmed by running a count on the table |
| | ‘vucd_user_votes’ that keeps track of each vote a user makes to |
| | prevent them from making multiple votes for the same product. |
| active | Will be set to 1 when this product is the one currently on Count Down |
| | sale. |

If there is no relationship made the product is not available for voting.

A product is available for countdown if it has a joining ID to the database table that holds countdown details. Checking to see if a user has already voted for a product is done by checking the ‘vucd_user_votes’ table for an entry with the users ID and the ID of the product they are viewing. When the Count Down product is changed from an active sale to a user confirmed sale it: adds the price of the product purchased to the ‘total_sales’ field on the ‘vucd-products’ entry and has the purchased amount removed from the products inventory.

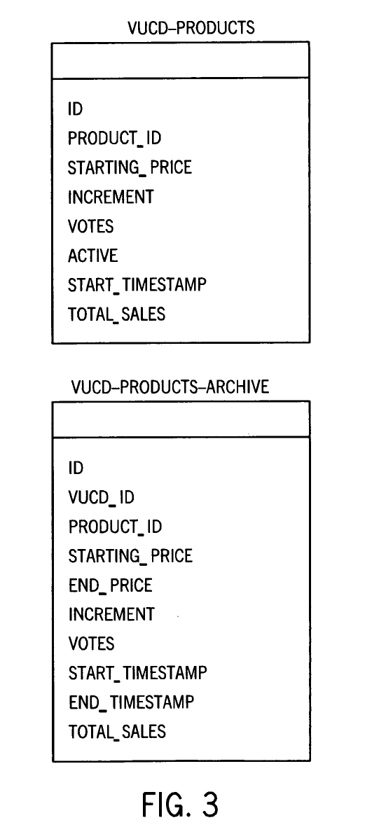

Referring now to FIG. 3, a ‘vucd-products’ database table is seen. The ‘vucd-products’ database table is used for storing the CountDown detail for each individual product. The CountDown detail for each individual product is kept in a separate table from the actual product to prevent empty entries on products that are not available for CountDowns.

Referring also to FIG. 3, a ‘vucd-products-archive’ database table is seen. The ‘vucd-products-archive’ database table is used to store basic details regarding past active CountDowns. This includes the length the CountDown took, the vucd_id to track to which active count down it is referring, and the total value of the product sold while on the sale.

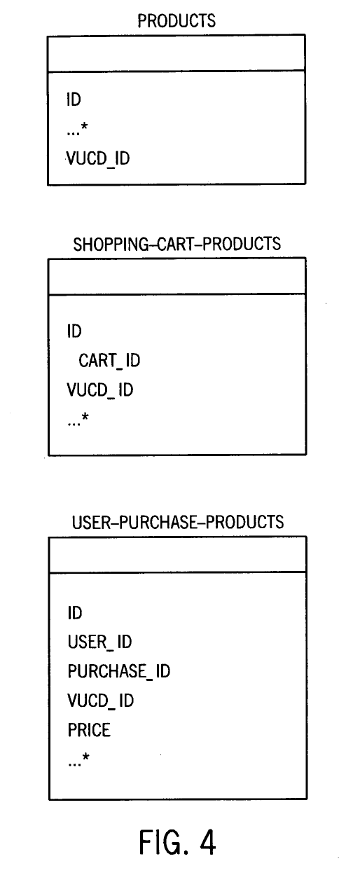

Referring now to FIG. 4, a ‘products’ database table is seen. The ‘products’ database table is used to store the general properties for products on the site. In order to normalize the data regarding the VUCD properties there is simply a reference (vucd_id) to the ‘vucd-products’ database table.

Referring also to FIG. 4, a ‘user-purchase-products’ database table is seen. The ‘user-purchase-products’ database table is used to store what products a user has purchased. The ‘user-purchase-products’ database table references the user, the product, and the active VUCD it was sold during (if any).

Still referring to FIG. 4, a ‘shopping-cart-products’ database table is seen. The ‘shopping-cart-products’ database table is used to store products a user has in their shopping cart. The ‘shopping-cart-products’ database table references the cart, the product, and the active VUCD (if it is the active VUCD).

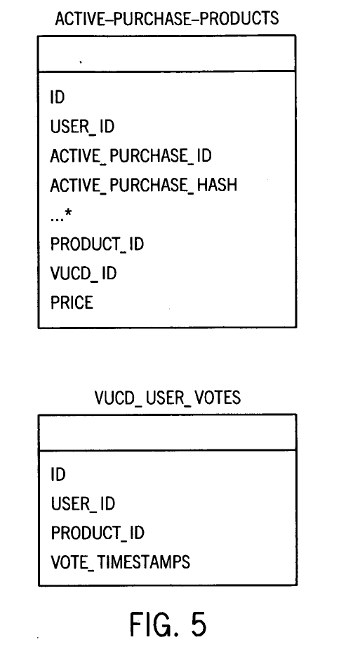

Referring now to FIG. 5, a ‘active-purchase-products’ database table is seen. The ‘active-purchase-products’ database table is similar to the ‘shopping-cart-products’ database table. The main difference is once a product is added to the ‘active-purchase-products’ database table and removed from the ‘shopping-cart-products’ table, other users are no longer able to purchase the quantity the first user has reserved. This is unless the first user takes longer then an allotted time period to complete their purchase, and it is then available to all other users again.

Referring also to FIG. 5, a ‘vucd_user_votes’ database table is seen. The vucd_user_votes’ database table is used to keep track of what products a user has already voted for. Each user is only allowed to vote for each product to go onto CountDown sale once. Once the sale has become active and then completed, the users vote is removed. This way if the product becomes available again, the user can vote on it again.

It should be understood that various changes and modifications preferred in to the embodiment described herein would be apparent to those skilled in the art. Such changes and modifications can be made without departing from the spirit and scope of the present invention and without demising its attendant advantages. It is therefore intended that such changes and modifications be covered by the appended claims.

What is claimed is:

1. An electronic commerce system of auctioning products on-line comprising:
a list of available products;
a voting system where customers are able to vote up a product; and
the product that the most customers have voted up goes to a countdown sale mode, wherein the product gets progressively less expensive until someone purchases the product.

2. The electronic commerce system of auctioning products on-line of claim 1 further wherein the product that the most customers have voted up will go to a “countdown” sale mode, where the product gets progressively less expensive, by one penny cheaper every second, until someone purchases the product.

3. The electronic commerce system of auctioning products on-line of claim 1 further wherein products that are more expensive than $864 count down at a pace that would bring it down to $0 in 24 hours.

4. The electronic commerce system of auctioning products on-line of claim 1 further wherein, once someone purchases the product, the next product with the most votes replaces it and goes into countdown mode.

5. The electronic commerce system of auctioning products on-line of claim 1 further wherein a customer can vote up as many products as they want, but they can only vote up each product one time.

6. The electronic commerce system of auctioning products on-line of claim 1 further including an on deck area with the next product with the most votes.

7. The electronic commerce system of auctioning products on-line of claim 6 further including an on deck area with the next three products with the most votes.

8. The electronic commerce system of auctioning products on-line of claim 1 further wherein a customer will get an automated e-mail when a product that they have voted up goes into countdown mode.

9. The electronic commerce system of auctioning products on-line of claim 1 further wherein a customer also will get an automated e-mail when something that they have “voted up” has entered the “on deck” area to go onto countdown sale.

10. A method of auctioning products on-line comprising:
providing a list of available products;
enabling customers to vote up products; and
placing the product that the most customers have voted up in a countdown sale mode, wherein the product gets progressively less expensive until someone purchases the product.

11. The method of auctioning products on-line of claim 10 further including placing the product that the most customers have voted up in a countdown sale mode, wherein the product gets progressively less expensive, by one penny cheaper every second, until someone purchases the product.

12. The method of auctioning products on-line of claim 10 further including counting down products that are more expensive than $864 at a pace that would bring it down to $0 in 24 hours.

13. The method of auctioning products on-line of claim 10 further wherein, once someone purchases the product, replacing the product with the next product with the most votes, which goes into countdown mode.

14. The method of auctioning products on-line of claim 10 further wherein a customer voting up as many products as they want, but they can only vote up each product one time.

15. The electronic commerce system of auctioning products on-line of claim 10 further including establishing an on deck area with the next product with the most votes.

16. The electronic commerce system of auctioning products on-line of claim 15 further including establishing an on deck area with the next three products with the most votes.

17. The electronic commerce system of auctioning products on-line of claim 10 further including providing a customer with an automated e-mail when a product that they have voted up goes into countdown mode.

18. The electronic commerce system of auctioning products on-line of claim 10 further including providing a customer with an automated e-mail when a product that they have voted up has entered the on deck area to go onto countdown sale.
